(19) United States
(12) Patent Application Publication
(10) Pub. No.: US 2013/0238190 A1
(43) Pub. Date: Sep. 12, 2013

(54) VEHICLE-MOUNTED APPLICATION MANAGEMENT DEVICE AND VEHICLE-MOUNTED APPLICATION MANAGEMENT METHOD

(71) Applicant: Toshihiro Yasuda, Tokyo (JP)

(72) Inventor: Toshihiro Yasuda, Tokyo (JP)

(73) Assignee: Toyota Jidosha Kabushiki Kaisha, Aichi-ken (JP)

(21) Appl. No.: 13/988,955

(22) PCT Filed: Nov. 24, 2011
(86) PCT No.: PCT/JP11/77006

§ 371 Date: May 22, 2013

(30) Foreign Application Priority Data
Nov. 24, 2010 (JP) 2010-261124

(51) Int. Cl. G06F 17/00

(52) U.S. Cl. CPC G06F 17/00
USPC 701/36

(57) ABSTRACT

A vehicle-mounted application management device manages an application that is executed by an information terminal mounted in a vehicle. The vehicle-mounted application management device comprises a management unit for detecting a vehicle state that is the state of the vehicle. The management unit is configured to manage, on the basis of the detected vehicle state, the on-off of at least one of a transmission path of input information given through the execution of the application and a transmission path of output information output through the execution of the application.

### TECHNICAL FIELD

The present disclosure relates to a vehicle-mounted application management device and a vehicle-mounted application management method for managing applications that are executed in a vehicle.

### BACKGROUND ART

As is known, vehicle-mounted information processing devices, or vehicle-mounted terminals such as navigation systems are mounted in vehicles. For example, a navigation system provides various functions such as a route search and shop guidance based on execution of applications corresponding to those functions. For example, to provide a route search, the navigation system outputs information on a searched route in the form of characters, images or sounds. Further, information necessary for the route search such as a destination and route points is input to the navigation system through a selection operation or a character input operation by a user, i.e. a driver.

Display information and sound information output from the vehicle-mounted terminal need to avoid affecting a driving operation, and an operation of inputting character information and the like to the vehicle-mounted terminal also should not be so complicated as to affect the driving operation. Accordingly, vehicle-mounted terminals have been conventionally proposed that input and output information in such a manner as not to affect a driving operation. As an example, Patent Document 1 discloses a vehicle-mounted terminal, i.e. an application execution device. An application control unit provided in this application execution device controls the operation of applications stored in an application storage unit according to a running state of a vehicle detected by a detection unit for detecting the running state of the vehicle. Specifically, when it is detected that the vehicle is running, the application control unit finishes applications for which functional limitation during the running of the vehicle is not set in advance. In this way, the applications that might affect the driving operation during the running of the vehicle are finished. This also prevents the applications from affecting the driving operation.

### PRIOR ART DOCUMENT

### Patent Document

Patent Document 1: Japanese Laid-Open Patent Publication No. 2005-28997

### SUMMARY OF THE INVENTION

### Problems that the Invention is to Solve

According to the vehicle-mounted terminal disclosed in Patent Document 1, the possibility of applications affecting driving operations is surely avoided. However, if applications for which functional limitation for the driving of a vehicle is not set in advance are, for example, uniformly finished each time the vehicle runs, some applications that have been operated halfway might be suddenly finished. This might largely impair the convenience of the applications. Because of this, various studies have been made on a preferable balance between to prevent the execution of the applications from affecting the driving operation and not to hinder the functions provided by the applications.

An object of the present disclosure is to provide a vehicle-mounted application management device capable of maintaining the convenience of applications while avoiding influence of applications executed in an information terminal mounted in a vehicle on a driving operation and to further provide a vehicle-mounted application management method.

### Means for Solving the Problems

In accordance with one aspect of the present disclosure, a vehicle-mounted application management device for managing an application that is executed in an information terminal mounted in a vehicle is provided. The vehicle-mounted application management device includes a management unit. The management unit is configured to detect a vehicle state, which is a state of the vehicle, and to manage, based on the detected vehicle state, on-off of at least one of a transmission path of input information that is assigned at execution of the application and a transmission path of output information that is output at execution of the application.

According to such a configuration, the transmission path of the input information that is assigned to the application and the transmission path of the output information output from the application are managed in correspondence with the vehicle state. From this, it is possible to restrict the transmission of the input information to the application and restrict the transmission of the output information from the application according to the vehicle state. Specifically, it is nothing more than the restriction of the input and output to and from the application while an executing state of the application is maintained. Thus, even if the input and output to and from the application are restricted, the operation of the application itself is continuously maintained. In this way, even if the vehicle state changes to a state where the application is temporarily restricted, the application can be successively utilized by removing the restricted state. As a result, it is possible to maintain the convenience of the application while preventing the application executed in the information terminal mounted in the vehicle from affecting a driving operation.

Further, for example, even if no sufficient consideration is made on an influence on the driving operation while the application has convenience, the vehicle-mounted application management device can manage the input and output information to and from the application based on the vehicle state. From this, even an application for which no sufficient consideration is made on an influence on the driving operation can be utilized in the information terminal.

In one form of the present disclosure, an output device for converting the output information into perceivable information and outputting the converted output information is mounted in the vehicle. The management unit is configured to manage the on-off of the transmission path of the output information to the output device.

For example, the application may output information that acts on the perception of a driver through output devices such as a display and a speaker, which are generally mounted in vehicles. According to the above configuration, it is possible to manage output information from such output devices that acts on perception, for such an application in a manner not to affect a driving operation of a driver, for example, in correspondence with the vehicle state.

In one form of the present disclosure, the input information is assigned to the application. The management unit is configured to manage the on-off of the transmission path of the input information assigned to the application.

According to such a configuration, an operation to the application is restricted through a management of on-off of the input information to the application. Thus, the application can be configured not to affect the driving operation.

In accordance with one form of the present disclosure, the management unit and the information terminal are integrally provided.

According to such a configuration, the management unit manages the input and output information corresponding to the application executed in the information terminal integrally provided to the management unit itself according to the vehicle state. Thus, the execution of the application by the information terminal affecting the driving operation is avoided. Therefore, the information terminal can be suitably utilized in the vehicle. This improves the mountability of the information terminal into the vehicle and improves the applicability of the vehicle-mounted application management device.

In accordance with one form of the present disclosure, the information terminal is configured to be externally connected to the management unit.

According to such a configuration, the input and output information corresponding to the application executed in the information terminal externally connected to the management unit is managed according to the vehicle state. For example, the information terminal is not designed to be vehicle mounted and cannot operate in consideration of an influence on a vehicle driving operation in some cases. Even in the case of utilizing such an information terminal, the input and output information of the application can be managed according to the vehicle state according to the above configuration. Thus, it is possible to utilize the externally connected information terminal in the vehicle while preventing an influence on the vehicle driving operation.

In accordance with one form of the present disclosure, the management unit includes a list in which applications confirmed to properly operate in the information terminal are registered. The management unit is configured to manage the on-off of the transmission path for applications not registered in the list.

According to such a configuration, the management unit manages the on-off of the transmission path of applications not written in the list according to the vehicle state. Thus, it is not necessary to manage applications that properly operate. That is, it is possible to efficiently perform the on-off management of the transmission paths of the input and output information of applications not confirmed to properly operate.

The application that properly operates need not be on the list. It normally takes time until an application is confirmed to properly operate and written in the list. Thus, an application that properly operates may be delivered before being written in the list. After the delivery, the application newly written in the list is excluded from on-off management targets by updating the list.

In accordance with one form of the present disclosure, the detected vehicle state is a running speed of the vehicle or a stopped state of the vehicle.

According to such a configuration, the management unit can manage the input and output information of the application according to the running speed of the vehicle or according to whether or not the vehicle is in the stopped state. Thus, the management unit blocks the input and output of the application so as not to affect the vehicle driving operation, for example, during the running of the vehicle. On the other hand, while the vehicle is stopped, the management unit prevents the restriction of the input and output of the application. In this way, the management unit maintains the convenience of the application while avoiding an influence of the application on the vehicle driving operation.

In accordance with one form of the present disclosure, the application is delivered to the vehicle from outside.

Applications to be delivered are convenient but, on the other hand, an influence on the vehicle driving operation is insufficiently considered or not considered at all for some of them. However, according to the above configuration, such applications can also be utilized in the vehicle while being prevented from affecting the vehicle driving operation. This increases the flexibility in the use of the applications. This also promotes an increase in the number of applications for vehicle-mounted information terminals.

In accordance with another aspect of the present disclosure, a vehicle-mounted application management method for managing an application that is executed in an information terminal mounted in a vehicle is provided. The vehicle-mounted application management method includes: acquiring a vehicle state that is a state of the vehicle; and managing, based on the acquired vehicle state, on-off of at least one of a transmission path of input information that is assigned at execution of the application and a transmission path of output information that is output at execution of the application.

### BRIEF DESCRIPTION OF THE DRAWINGS

FIG. 1 is a block diagram showing a schematic configuration of one embodiment, illustrating a vehicle in which a vehicle-mounted application management device according to the present disclosure is provided;

FIG. 2 is a flowchart showing processing steps when the vehicle-mounted application management device of FIG. 1 executes restriction-during-running for applications;

FIG. 3 is a flowchart showing a processing step when the vehicle-mounted application management device of FIG. 1 removes the restriction-during-running for the applications;

FIG. 4 is a block diagram showing an operation example of the vehicle-mounted application management device of FIG. 1; and

FIG. 5 is a block diagram showing a schematic configuration of another embodiment.

### MODES FOR CARRYING OUT THE INVENTION

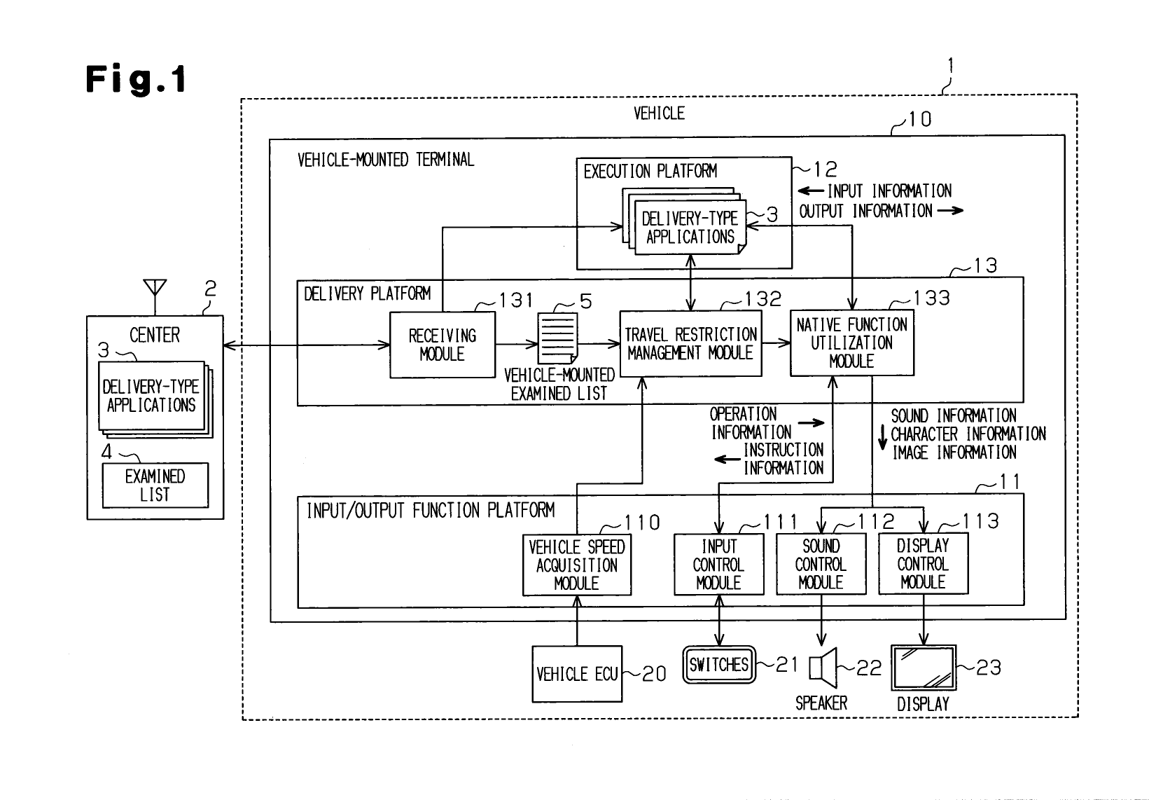

FIGS. 1 to 4 show a vehicle-mounted application management device according to one embodiment of the present disclosure. First, the outline of the vehicle-mounted application management device is described.

As shown in FIG. 1, a vehicle-mounted terminal 10 as an information terminal mounted in a vehicle 1 configures a vehicle-mounted application management device. An information center 2 as a center capable of wireless communication with the vehicle-mounted terminal 10 exists outside the vehicle 1. The vehicle-mounted terminal 10 provides functions of delivery-type applications 3 to a driver or the like by executing the delivery-type applications 3 delivered from the information center 2. The vehicle-mounted terminal 10 executes restriction-during-running to restrict functions and operations provided by the delivery-type applications 3 during the running of the vehicle. Such restriction-during-running is executed to prevent the operation and function of the delivery-type applications 3 from affecting a driving operation performed on the running vehicle 1. The delivery-type applications 3 are normally executed in a normal operation mode where there is no restriction-during-running and executed in a restriction-during-running mode corresponding to the restriction-during-running when the restriction-during-running is necessary. When restriction-during-running functions built into the delivery-type applications 3 are executed by executing the delivery-type applications 3 in the restriction-during-running mode, the restriction-during-running is executed. Such restriction-during-running functions include functions of inhibiting such screen changes that attract the driver's attention and inhibiting an operation request. However, the restriction-during-running functions built into the delivery-type applications 3 may be insufficient in some cases. In other cases, the restriction-during-running functions are not built into the delivery-type applications 3 at all since the delivery-type application 3 is a general-purpose application not limited to a vehicle-mounted application. Accordingly, the vehicle-mounted terminal 10 of this embodiment executes a forcible restriction-during-running mode for forcibly executing the restriction-during-running for a delivery-type application 3 of which the restriction-during-running functions are insufficient or into which no restriction-during-running function is built.

There are delivery-type applications 3 of which the restriction-during-running is insufficient and general-purpose delivery-type applications 3 for which no restriction-during-running is executed. These applications 3 only cause the restriction-during-running not to be properly executed, but the use thereof in the vehicle 1 is often useful. It increases the utility value of the vehicle-mounted terminal 10 through an improvement in application convenience to properly use such useful delivery-type applications 3 in the vehicle-mounted terminal 10. Consequently, this contributes to an improvement in convenience for the driver and the like. Thus, the delivery-type applications 3 handled in this embodiment also include applications for which proper restriction-during-running cannot be executed.

The information center 2 retains a plurality of delivery-type applications 3 and a reviewed application list 4 in a deliverable manner and manages the delivery of these. The information center 2 receives a delivery request of a delivery-type application 3 from the vehicle-mounted terminal 10. Then, the vehicle-mounted terminal 10 transmits the delivery-type application 3 corresponding to the delivery request to the vehicle-mounted terminal 10 as a requestor by data communication using wireless communication or wired communication. The information center 2 refers to the reviewed application list 4 in delivering the delivery-type application 3. The information center 2 adds review completion information to the delivery-type application 3 and delivers the delivery-type application 3 to the vehicle-mounted terminal 10 when determining that the delivery-type application 3 is registered in the reviewed application list 4.

Information capable of identifying the delivery-type applications 3 including a built-in function of executing a proper restriction-during-running during the running of the vehicle is recorded in the reviewed application list 4. For example, an identification number uniquely assigned to each delivery-type application 3 is information capable of identifying the delivery-type applications 3 including the built-in function of executing the restriction-during-running. That is, the identification numbers are recorded in the reviewed application list 4. Only the identification numbers of the delivery-type applications 3 confirmed to include the built-in function of executing the proper restriction-during-running during the running of the vehicle by a review conducted in accordance with a predetermined rule are registered in the reviewed application list 4. That is, the “review” in this embodiment confirms whether or not the delivery-type application 3 includes the built-in function of executing the proper restriction-during-running during the running of the vehicle. The information center 2 can determine whether or not the proper restriction-during-running function is built into each delivery-type application 3 by referring to the reviewed application list 4. When the information center 2 retains a delivery-type application 3 including the built-in function of executing the proper restriction-during-running, the identification number of the delivery-type application 3 is added to the reviewed application list 4. Also when a delivery-type application 3 that has already been retained in the information center 2, but not recorded in the reviewed application list 4 is confirmed to be an application including the built-in function of executing the proper restriction-during-running in a later review, the identification number of the delivery-type application 3 is added to the reviewed application list 4. At this time, the delivery-type application 3 added with the review completion information is delivered to the vehicle-mounted terminal 10 by updating the delivery-type application 3 after the delivery-type application 3 is registered in the reviewed application list 4.

The vehicle 1 is an automotive vehicle as a mobile body. The vehicle-mounted terminal 10 that is, for example, a navigation system that is a vehicle-mounted information terminal mounted in the vehicle 1. Specifically, the vehicle-mounted terminal 10 of this embodiment detects the present position of the vehicle 1 utilizing a global positioning system (GPS) or the like. The vehicle-mounted terminal 10 guides the drive through a running route or the like of the vehicle 1 to a destination by referring to map information stored in advance based on the detected present position. Further, a vehicle ECU 20, which obtains a speed and an acceleration of the vehicle 1 or measurement values such as an engine rotation speed and temperature from various sensors, is provided in the vehicle 1. Furthermore, the vehicle 1 includes switches 21, a speaker 22 and a display 23. The switches 21 are operation buttons, a touch panel and the like for outputting operation information corresponding to an operation by the driver. The speaker 22 outputs audible information output from the vehicle-mounted terminal 10 in the form of sounds perceivable by the driver. The display 23 displays character information and image information output from the vehicle-mounted terminal 10 on a screen in a manner perceivable by the driver.

The vehicle ECU 20 can transmit the obtained values such as the speed, acceleration, engine rotation speed and temperature of the vehicle 1 to the vehicle-mounted terminal 10 via a vehicle-mounted network of a control system such as a CAN (Controller Area Network).

The switches 21 can transmit operation information to the vehicle-mounted terminal 10 via a vehicle-mounted network such as a LIN (Local Interconnect Network) and signal lines and receive instruction information from the vehicle-mounted terminal 10. In this way, the switches 21 input the operation information to the vehicle-mounted terminal 10 by outputting it, and the instruction information to change the color of the switches 21 to indicate to the driver or the like whether or not the switches 21 receive an operation by color or the like is input from the vehicle-mounted terminal 10.

Corresponding sound information, character information and image information are respectively input to the speaker 22 and the display 23 from the vehicle-mounted terminal 10 via an information-type vehicle-mounted network such as the Ethernet® and signal lines.

Next, the configuration of the vehicle-mounted application management device of this embodiment will be described.

A microcomputer (not shown) including a CPU for executing various arithmetic processes, a ROM storing various control programs, a RAM used as a work area for data storage and program execution, a memory (storage device including a nonvolatile memory) and the like is provided in the vehicle-mounted terminal 10. Various platforms configured to include information processing by this microcomputer are provided in the vehicle-mounted terminal 10. Specifically, an input/output function platform 11 for managing data communication via various vehicle-mounted networks and the input and output of signals via signal lines, an execution platform 12 as an information terminal for executing the delivery-type applications 3 and a delivery platform 13 for managing the restriction-during-running for the delivery-type applications 3 are provided in the vehicle-mounted terminal 10.

The execution platform 12 can receive delivery-type applications 3 from the delivery platform 13 and execute the received delivery-type applications 3. The execution platform 12 can receive a plurality of delivery-type applications 3 and retain them in a non-illustrated storage device or the like, and execute each of the plurality of delivery-type applications 3. The execution platform 12 receives input information that is assigned to the executed delivery-type application 3 from the delivery platform 13 and, on the other hand, transmits output information output from the delivery-type application 3 to the delivery platform 13. The input information includes the aforementioned operation information and the output information includes at least one of the aforementioned instruction information, sound information, character information or image information. The delivery platform 13 assigns an identification number capable of identifying the delivery-type application 3 to the output information of the delivery-type application 3.

A vehicle speed acquisition module 110, which enables information transmission between the vehicle ECU 20 and the delivery platform 13, and an input control module 111 as a transmission path that enables information transmission between the switches 21 and the delivery platform 13 are provided in the input/output function platform 11. A sound control module 112 as a transmission path that enables information transmission from the delivery platform 13 to the speaker 22 and a display control module 113 as a transmission path that enables information transmission from the delivery platform 13 to the display 23 are provided in the input/output function platform 11.

The vehicle speed acquisition module 110 acquires a vehicle speed, which is a speed of the vehicle 1, from the vehicle ECU 20 connected via the vehicle-mounted network of the control system such as a CAN and transmits the acquired vehicle speed to the delivery platform 13.

The input control module 111 acquires the operation information from the switches 21 connected via the vehicle-mounted network such as a LIN and signal lines and transmits the acquired operation information to the delivery platform 13. On the other hand, the input control module 111 transmits the instruction information transmitted from the delivery platform 13 to the switches 21. The input control module 111 can stop the transmission of the information according to a predetermined condition. Specifically, the input control module 111 can prevent the transmission of the acquired operation information to the delivery platform 13 under a predetermined condition and, conversely, prevent the transmission of the instruction information transmitted from the delivery platform 13 to the switches 21. The input control module 111 of this embodiment can identify the identification number of the delivery-type application 3 included in the instruction information and assign the identification number of the corresponding delivery-type application 3 to the operation information. In this way, the input control module 111 can manage transmission and interruption of the operation information and the instruction information being handled (on-off management), for example, based on the identification number as a condition.

The sound control module 112 transmits the sound information transmitted from the delivery platform 13 to the speaker 22, whereas the display control module 113 transmits the character information and the image information transmitted from the delivery platform 13 to the display 23. The sound control module 112 and the display control module 113 can stop the transmission of the information according to a predetermined condition. Specifically, under the predetermined condition, the sound control module 112 can prevent the transmission of the sound information transmitted from the delivery platform 13 to the speaker 22 and the display control module 113 can prevent the transmission of the character information and the image information transmitted from the delivery platform 13 to the display 23. The sound control module 112 of this embodiment can also identify the identification number of the delivery-type application 3 included in the sound information and the display control module 113 can also identify the identification number of the delivery-type application 3 included in the character information and the image information. In this way, the sound control module 112 and the display control module 113 can manage on-off of various pieces of information being handled, for example, based on the identification number as a condition.

When receiving a restriction-during-running signal generated in the delivery platform 13 from the delivery platform 13 during the running of the vehicle, the execution platform 12 transmits the restriction-during-running signal to the delivery-type application 3 in execution. The delivery-type application 3, which includes the built-in restriction-during-running function, performs such restriction as to become, for example, non-reactive to input information and outputs output information restricted so as not to affect a driving operation when receiving the restriction-during-running signal. The execution platform 12 executes the delivery-type application 3 and also executes a basic application and the like mounted in advance in the vehicle-mounted terminal 10 to provide basic functions as a navigation system.

The delivery platform 13 includes a receiving module 131 for carrying out various data communications with the information center 2, a restriction-during-running management module 132 as a management unit and a native function utilization module 133. The restriction-during-running management module 132 generates a restriction-during-running signal according to the vehicle speed transmitted from the vehicle speed acquisition module 110 and transmits it to the execution platform 12 and the like. Further, the restriction-during-running management module 132 acquires information of the delivery-type application 3 being executed in the execution platform 12. The native function utilization module 133 can transmit information to and from the execution platform 12 and the input/output function platform 11.

The receiving module 131 requests the delivery of a delivery-type application 3 to the information center 2, acquires the delivery-type application 3 delivered from the information center 2 in response to the delivery request and transmits it to the execution platform 12. Further, the receiving module 131 adds the identification number of the delivery-type application 3 in a vehicle-mounted reviewed application list 5 retained in a non-illustrated storage device if the review completion information is added to the acquired delivery-type application 3.

The restriction-during-running management module 132 determines whether or not the vehicle 1 is running, or conversely in a stopped state based on the speed of the vehicle 1 transmitted from the vehicle speed acquisition module 110. The restriction-during-running management module 132 generates a restriction-during-running signal based on the determination that the vehicle 1 is running, i.e. the determination that the vehicle 1 is not in the stopped state. The restriction-during-running management module 132 transmits the generated restriction-during-running signal to the execution platform 12. As a result, the restriction-during-running management module 132 enables the restriction-during-running of the delivery-type application 3 being executed in the execution platform 12. The restriction-during-running management module 132 detects whether or not there is any unregistered delivery-type application 3 not registered in the vehicle-mounted reviewed application list 5 by checking the vehicle-mounted reviewed application list 5 and the delivery-type application 3 being executed in the execution platform 12 when a condition to generate the restriction-during-running signal is met. If any unregistered delivery-type application 3 is detected, the restriction-during-running management module 132 transmits the identification number of the unregistered delivery-type application 3 to the native function utilization module 133 under the same condition as the condition to generate the restriction-during-running signal.

The native function utilization module 133 transmits the operation information input from the input control module 111 as input information to the execution platform 12. On the other hand, the native function utilization module 133 transmits output information output through the execution platform 12 with the execution of the delivery-type application 3 to the input/output function platform 11. Specifically, the native function utilization module 133 transmits instruction information included in the output information to the input control module 111 and transmits sound information included in the output information to the sound control module 112. Further, the native function utilization module 133 transmits character information and image information included in the output information to the display control module 113.

The native function utilization module 133 receives the notification of the identification number of the unregistered delivery-type application 3 from the restriction-during-running management module 132 under the condition to generate the restriction-during-running signal. Then, the native function utilization module 133 causes the input of information to the delivery-type application 3 that corresponds to the notified identification number and the output of information from the delivery-type application 3 to be respectively restricted. Specifically, the native function utilization module 133 transmits the notified identification number to the input control module 111, the sound control module 112 and the display control module 113. In this way, the input control module 111 stops the output of the operation information of the switches 21 corresponding to the notified identification number to the native function utilization module 133. That is, the input control module 111 prevents the transmission of the input information based on the above operation information to the execution platform 12. Further, the input control module 111 stops the output of the instruction information to the switches 21 based on the notified identification number. That is, the input control module 111 prevents the transmission of the instruction information based on the output information from the delivery-type application 3 to the switches 21. Further, the sound control module 112 stops the output of the sound information to the speaker 22 based on the notified identification number. That is, the sound control module 112 prevents the transmission of the sound information based on the output information from the delivery-type application 3 to the speaker 22. Further, the display control module 113 stops the output of the character information and the image information to the display 23 based on the notified identification number. That is, the display control module 113 prevents the transmission of the character information and the image information based on the output information from the delivery-type application 3 to the speaker 22. In this way, the input control module 111, the sound control module 112 and the display control module 113 respectively restrict the input and output based on the operation information, the instruction information, the sound information, the character information and the image information corresponding to the notified identification number.

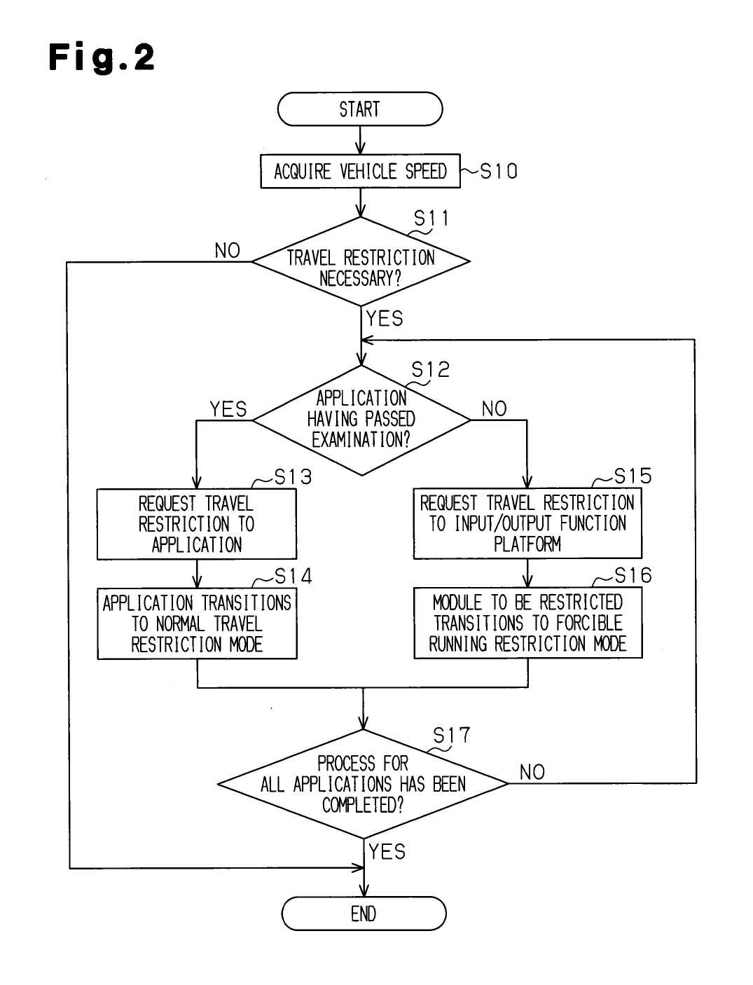

FIGS. 2 to 4 show functions of the vehicle-mounted application management device of this embodiment.

First, the vehicle-mounted terminal 10 requests the delivery of a delivery-type application 3 to the information center 2 in response to an instruction from the driver or the like. To make this delivery request, a list of applications that can be delivered by the information center 2 is, for example, delivered in advance from the information center 2 to the vehicle-mounted terminal 10. The driver selects an application from this deliverable list. The information center 2 having received the delivery request from the vehicle-mounted terminal 10 prepares for the delivery of the requested delivery-type application 3. In preparing for the delivery, the information center 2 determines whether or not the delivery-type application 3 being prepared for the delivery is registered in the reviewed application list 4. If the delivery-type application 3 being prepared for the delivery is registered in the reviewed application list 4, the information center 2 finishes the delivery preparation by adding the review completion information to the delivery-type application 3. On the other hand, if the delivery-type application 3 being prepared for the delivery is not registered in the reviewed application list 4, the information center 2 finishes the delivery preparation without adding the review completion information to the delivery-type application 3. The information center 2 delivers the delivery-type application 3, for which the delivery preparation was finished, to the vehicle-mounted terminal 10.

The delivery platform 13 receives the delivery-type application 3 delivered from the information center 2 and saves it in the execution platform 12. If the review completion information is added to the delivery-type application 3, the delivery platform 13 adds the identification number of the delivery-type application 3 to the vehicle-mounted reviewed application list 5. On the other hand, if the review completion information is not added to the delivery-type application 3, the delivery platform 13 does not add the identification number of the delivery-type application 3 to the vehicle-mounted reviewed application list 5. In this way, a plurality of delivery-type applications 3 and the vehicle-mounted reviewed application list 5 are retained in the vehicle-mounted terminal 10. Thereafter, the execution platform 12 of the vehicle-mounted terminal 10 executes the delivery-type application 3 in accordance with the operation of the driver and the like.

When the vehicle is in the stopped state, the vehicle-mounted terminal 10 sequentially performs a process for executing the restriction-during-running when the vehicle 1 is eventually set in a running state, i.e. a process for transition to the execution of the delivery-type application 3 in the restriction-during-running mode at predetermined time intervals. Specifically, as shown in FIG. 2, the delivery platform 13 of the vehicle-mounted terminal 10 acquires the vehicle speed (Step S10 of FIG. 2) and determines whether or not the restriction-during-running is necessary for the delivery-type application 3 based on the acquired vehicle speed (Step S11 of FIG. 2). Whether or not the restriction-during-running is necessary for the delivery-type application 3 is determined based on whether or not the vehicle 1 is in the stopped state. Specifically, if the vehicle 1 is in the stopped state, the restriction-during-running is determined to be unnecessary for the delivery-type application 3. On the other hand, if the vehicle 1 is running, the delivery platform 13 determines that the restriction-during-running is necessary for the delivery-type application 3. If the restriction-during-running is determined to be unnecessary (NO in Step S11 of FIG. 2), the vehicle-mounted terminal 10 (delivery platform 13) finishes the process for executing the restriction-during-running.

If the restriction-during-running is determined to be necessary (YES in Step S11 of FIG. 2), the delivery platform 13 determines whether or not one delivery-type application 3 selected from a plurality of delivery-type applications 3 in execution is an application having passed the review (Step S12 of FIG. 2). Whether or not the delivery platform 13 is an application having passed the review is determined based on whether or not the identification number of the selected delivery-type application 3 is registered in the vehicle-mounted reviewed application list 5. If the delivery platform 13 in execution is determined to be an application having passed the review (YES in Step S12 of FIG. 2), the delivery platform 13 requests the restriction-during-running to the delivery-type application 3 by transmitting an operation restriction signal to the execution platform 12 (Step S13 of FIG. 2). In this way, the delivery-type application 3 having the restriction-during-running function transitions from a normal operation mode to an operation in a mode corresponding to the restriction-during-running, i.e. an operation in a normal restriction-during-running mode.

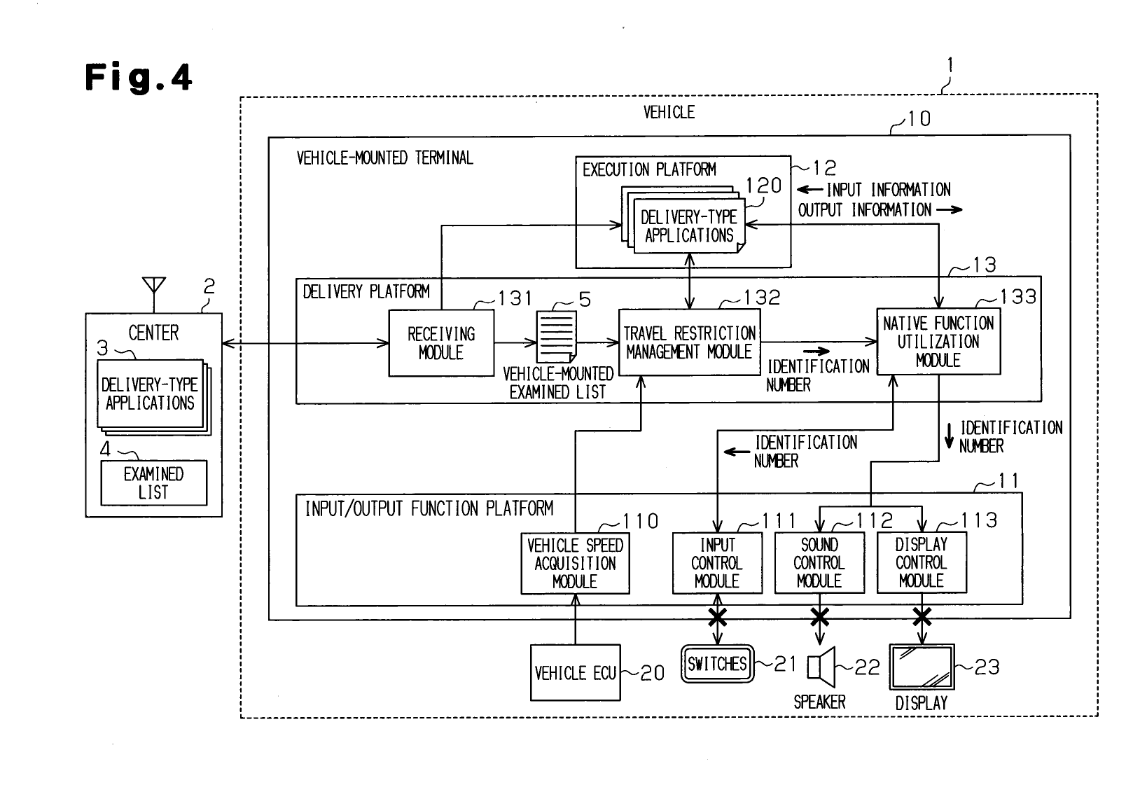

On the other hand, if the delivery platform 13 determines that “the delivery-type application 3 in execution is an unreviewed application” (NO in Step S12 of FIG. 2), the delivery platform 13 requests the restriction-during-running to the input/output function platform 11 (Step S15 of FIG. 2). Specifically, the delivery platform 13 notifies the identification number of the unreviewed delivery-type application 3 to each of the input control module 111, the sound control module 112 and the display control module 113. In this way, a transition is made to the forcible restriction-during-running mode (Step S16 of FIG. 2). In the forcible restriction-during-running mode, the input/output function platform 11 forcibly restricts the output information of the delivery-type application 3. This causes the input and output between the delivery platform 13 and the switches 21 and the output from the delivery platform 13 to the speaker 22 and the display 23 to be restricted as shown in FIG. 4. On the other hand, the operations of the delivery-type application 3 and the like are maintained in a normal state. For example, if a transition is made to the forcible restriction-during-running mode in a mode in which the display 23 displays icons of the switches 21, the speaker 22, the display 23 and the like, the delivery platform 13 masks the icons of the switches 21, the speaker 22 and the display 23 for which the restriction-during-running is executed. By doing so, the vehicle-mounted terminal 10 may show a running restricted state to the driver.

The delivery platform 13 determines whether or not to set the operation of a certain delivery-type application 3 in the normal restriction-during-running mode. When a transition is made to the forcible restriction-during-running mode, the delivery platform 13 determines whether or not the process for all the delivery-type applications 3 in execution has been finished (Step S17 of FIG. 2). If determining that the process for all the delivery-type applications 3 in execution has not been finished yet (NO in Step S17 of FIG. 2), the delivery platform 13 returns to Step S12 and newly selects the delivery-type application 3 in execution which has not yet transitioned to the restriction-during-running mode. Then, the delivery platform 13 performs a process for making the delivery-type application 3 transition to the restriction-during-running mode.

On the other hand, the delivery platform 13 finishes the process for making the delivery-type application 3 transition to the restriction-during-running mode if determining that the process for all the delivery-type applications 3 in execution has been finished (YES in Step S17 of FIG. 2).

Next, the operation of the delivery-type application 3 that has been made to transition to the forcible restriction-during-running mode as described above will be described. As shown in FIG. 4, the identification number of the delivery-type application 3 in which the forcible restriction-during-running mode is executed is notified to each module (111, 112, 113), which manages on-off of the information transmission path. The input control module 111 stops the output to the native function utilization module 133 when the operation information is input to the switches 21 corresponding to the identification number notified to execute the forcible restriction-during-running mode from the driver or the like. By doing so, the input control module 111 prevents the transmission of the input information based on the operation information of the switches 21 to the execution platform 12. The input control module 111 stops the output of the instruction information to the switches 21 when the instruction information to the switches 21 is received from the delivery-type application 3 having the identification number notified to execute the forcible restriction-during-running mode. Thus, there is no change in the switches 21 based on the instruction information. Further, the sound control module 112 stops the output of the sound information to the speaker 22 when the sound information to the speaker 22 is input from the delivery-type application 3 having the identification number notified to execute the forcible restriction-during-running mode. Thus, the speaker 22 does not output any sound based on the sound information. Further, the display control module 113 stops the output of the character information and the image information to the display 23 when the character information and the image information to the display 23 are input from the delivery-type application 3 having the identification number notified to execute the forcible restriction-during-running mode. Thus, the display 23 does not display any characters or images based on the character information and the image information. In this way, the input information to the delivery-type application 3 executed in the forcible restriction-during-running mode is restricted. In addition, the output information output from the delivery-type application 3 executed in the forcible restriction-during-running mode is restricted.

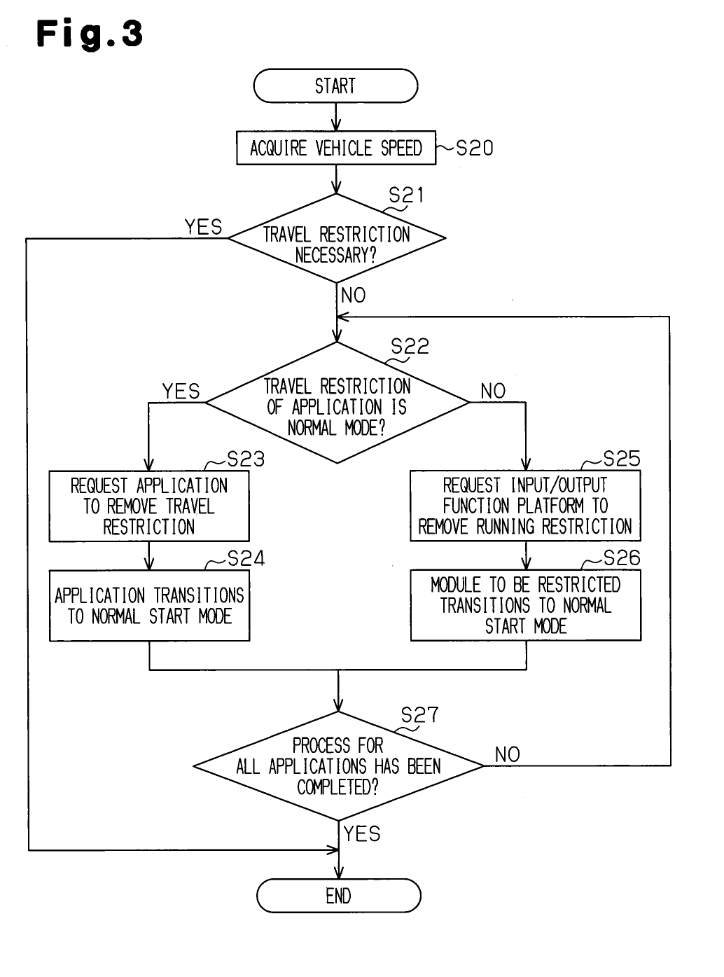

On the other hand, when the vehicle is running, the delivery platform 13 sequentially performs at predetermined time intervals a process for removing the restriction-during-running of the delivery-type application 3 when the vehicle 1 is eventually set in the stopped state, i.e. a process for making the delivery-type application 3 transition to the execution in the normal operation mode. As shown in FIG. 3, the delivery platform 13 acquires the vehicle speed (Step S20 of FIG. 3) and determines whether or not the restriction-during-running is necessary for the delivery-type application 3 based on the acquired vehicle speed (Step S21 of FIG. 3). If the vehicle 1 is running, the delivery platform 13 determines that the restriction-during-running is necessary. On the other hand, if the vehicle 1 is in the stopped state, the delivery platform 13 determines that the restriction-during-running of the delivery-type application 3 is unnecessary. If the restriction-during-running is determined to be necessary (YES in Step S21 of FIG. 3), the delivery platform 13 temporarily finishes the process for removing the restriction-during-running of the delivery-type application 3.

If the restriction-during-running is determined to be unnecessary (NO in Step S21 of FIG. 3), the delivery platform 13 determines whether or not the restriction-during-running of one delivery-type application 3 selected from a plurality of delivery-type applications 3 in execution is a normal restriction-during-running mode (Step S22 of FIG. 3). Whether or not the restriction-during-running is the normal restriction-during-running mode is determined based on whether or not the identification number of the selected delivery-type application 3 is registered in the vehicle-mounted reviewed application list 5. If determining that “the delivery-type application 3 in execution is in the normal restriction-during-running mode” (YES in Step S22 of FIG. 3), the delivery platform 13 finishes the transmission of the operation restriction signal and requests the execution platform 12 to remove the restriction-during-running of the delivery-type application 3 (Step S23 of FIG. 3). Thus, the restriction-during-running is removed from the delivery-type application 3 having the restriction-during-running function and a transition is made from an operation in the restriction-during-running mode to the one in the normal operation mode.

On the other hand, if determining that “the delivery-type application 3 in execution is not in the normal running mode” (NO in Step S22 of FIG. 3), the delivery platform 13 requests that the input/output function platform 11 removes the restriction-during-running (Step S25 of FIG. 3). Specifically, the delivery platform 13 finishes the notification of the identification number of the delivery-type application 3, which has not been reviewed yet, to each of the input control module 111, the sound control module 112 and the display control module 113. In this way, the forcible restriction of the input and output information of the delivery-type application 3 by the input/output function platform 11 is removed. Thus, the delivery-type application 3 transitions from the forcible restriction-during-running mode to the normal operation mode (Step S26 of FIG. 3).

After making the operation of a certain delivery-type application 3 transition to the normal operation mode, the delivery platform 13 determines whether or not the process for all the delivery-type applications 3 in execution has been finished (Step S27 of FIG. 3). If determining that the process for all the delivery-type applications 3 in execution has not finished yet (NO in Step S27 of FIG. 3), the delivery platform 13 returns to Step S22 and selects the delivery-type application 3 in execution anew, which has not yet transitioned to the normal operation mode. Then, the delivery platform 13 performs a process for making the remaining delivery-type applications 3 transition to the normal operation mode.

On the other hand, if determining that the process for all the delivery-type applications 3 in execution has finished (YES in Step S27 of FIG. 3), the delivery platform 13 finishes the process for making the delivery-type application 3 transition to the normal operation mode.

On the other hand, if the restriction-during-running of the delivery-type application 3 is determined to be unnecessary (NO in Step S21 of FIG. 3), the delivery platform 13 stops the notification of the restriction-during-running signal from the restriction-during-running management module 132 and stops all the notifications of the identification numbers. By doing so, the delivery platform 13 can complete the process for making the delivery-type application 3 transition to the normal operation mode.

As described above, advantages listed below can be obtained according to the vehicle-mounted application management device of this embodiment.

(1) The transmission paths of the input information applied to the delivery-type application 3 and the output information output from the delivery-type application 3 are managed to be on and off based on whether or not the vehicle 1 is in the stopped state. This enables the transmission of the input information to the delivery-type application 3 and the transmission of the output information from the delivery-type application 3 to an output device to be restricted according to the stopped state of the vehicle 1. Specifically, it is nothing more than the restriction of the input and output of the delivery-type application 3 while an executing state of the delivery-type application 3 is maintained. Thus, even if the input and output of the delivery-type application 3 are restricted, the operation of the delivery-type application 3 itself is continuously maintained. Therefore, even if the delivery-type application 3 is temporarily restricted because the vehicle 1 is running, the delivery-type application 3 can be continuously utilized by removing the restricted state. As a result, the convenience of the delivery-type application 3 can be maintained while the delivery-type application 3 being executed in the execution platform 12 mounted in the vehicle 1 is prevented from affecting the driving operation during the running of the vehicle 1.

(2) For example, even if no sufficient consideration is made for an influence of the delivery-type application 3 on the driving operation while the delivery-type application 3 has convenience, the delivery platform 13 can manage the input and output information of such a delivery-type application 3 based on the stopped state of the vehicle 1. Thus, the execution platform 12 can also utilize the delivery-type application 3 for which no sufficient consideration is made for an influence on the driving operation.

(3) For example, the delivery-type application 3 may output information that acts on the perception of the driver through output devices such as the display 23 and the speaker 22, which are generally mounted in the vehicle 1. The delivery platform 13 can manage output of the output information that acts on perception for such a delivery-type application 3 in a manner not to affect the driving operation, for example, in correspondence with the running state of the vehicle 1.

(4) The delivery platform 13 restricts an operation to the delivery-type application 3 through the on-off management of the input information to the delivery-type application 3. Thus, the delivery-type application 3 does not affect the driving operation.

(5) The execution platform 12 and the restriction-during-running management module 132 are integrally provided to the vehicle-mounted terminal 10. The restriction-during-running management module 132 manages the input and output information corresponding to the delivery-type application 3 being executed in the execution platform 12 according to the stopped state of the vehicle 1. Thus, the execution of the delivery-type application 3 by the execution platform 12 affecting the driving operation is avoided. Therefore, the vehicle-mounted terminal 10 including the execution platform 12 can be suitably utilized in the vehicle 1. This improves the mountability of the vehicle-mounted terminal 10 including the execution platform 12 into the vehicle 1. Further, the applicability of the vehicle-mounted application management device is improved.

(6) The delivery platform 13 manages on-off of the transmission path of a delivery-type application 3 not written in the vehicle-mounted reviewed application list 5 according to the stopped state of the vehicle 1. Thus, the vehicle-mounted terminal 10 need not manage delivery-type applications 3 that properly operate. Therefore, the vehicle-mounted terminal 10 can efficiently manage the on-off of the transmission path of the delivery-type application 3 confirmed not to properly operate.

Delivery-type applications 3 that properly operate do not necessarily need to be written in the vehicle-mounted reviewed application list 5. It normally takes time until a delivery-type application 3 is confirmed to normally operate and written in the vehicle-mounted reviewed application list 5. Thus, a delivery-type application 3 that properly operates may be delivered before being written in the vehicle-mounted reviewed application list 5. After the delivery, the delivery-type application 3 newly written in the vehicle-mounted reviewed application list 5 is excluded from on-off management targets by updating the vehicle-mounted reviewed application list 5 with the updating of the delivery-type application 3 or the like.

(7) The vehicle-mounted terminal 10 manages the input and output information of the application according to the vehicle speed of the vehicle 1 or according to whether the vehicle 1 is in the stopped state. Thus, the vehicle-mounted terminal 10 blocks the input and output of the delivery-type application 3 so as not to affect the vehicle driving operation, for example, during the running of the vehicle. On the other hand, while the vehicle is stopped, the vehicle-mounted terminal 10 can prevent the restriction of the input and output of the delivery-type application 3. In this way, the vehicle-mounted terminal 10 can maintain the convenience of applications while avoiding influences of the applications on the vehicle driving operation.

(8) Some delivery-type applications 3 delivered from outside are convenient but, on the other hand, influences on the driving operation is insufficiently considered or not considered at all for them. However, the vehicle-mounted terminal 10 can utilize even such delivery-type applications 3 while preventing them from affecting the driving operation in the vehicle 1. This increases flexibility of the use of delivery-type applications 3. This can also promote an increase in the number delivery-type applications 3 for the vehicle-mounted terminal 10 mounted while including the execution platform 12.

The above embodiment can also be carried out as follows.

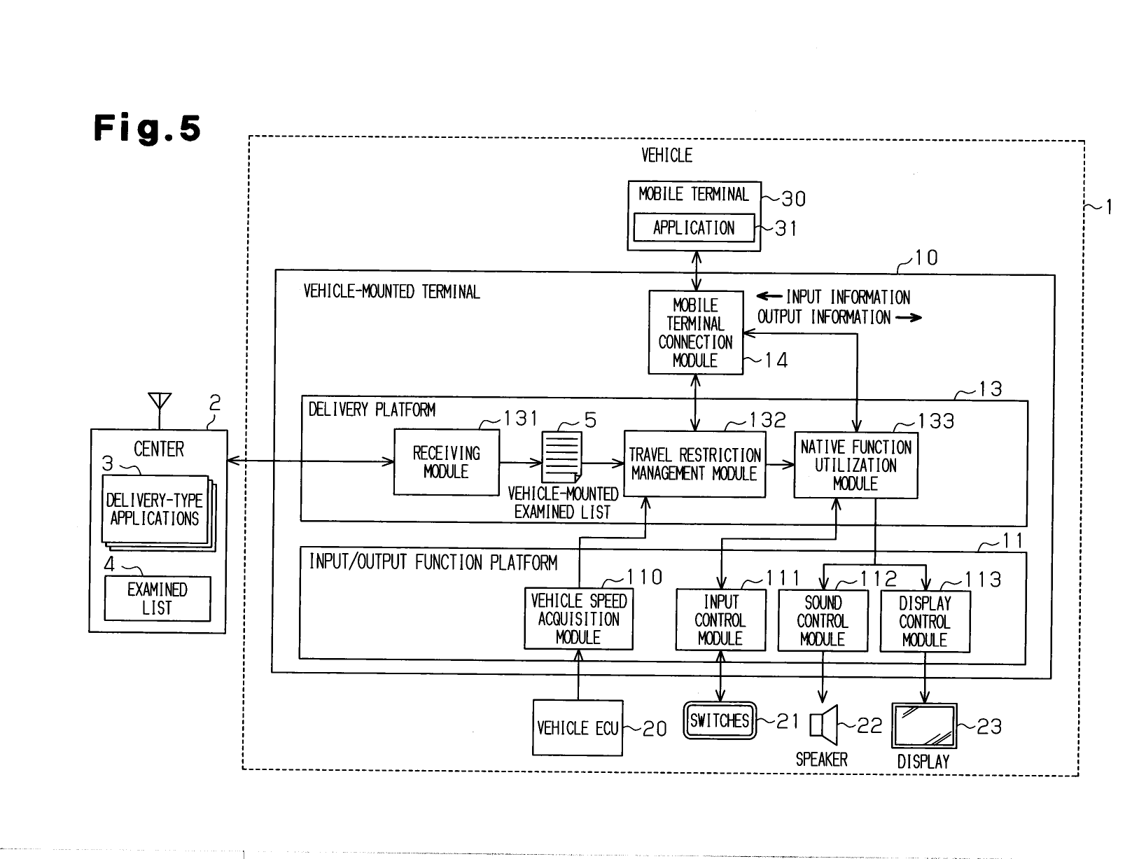

In the above embodiment, the case is illustrated where the delivery-type application 3 is executed in the vehicle-mounted terminal 10, particularly in the execution platform 12. However, without being limited to this, an application may be executed outside a vehicle-mounted terminal. Then, output information from the application may be input to the vehicle-mounted terminal. Conversely, input information to an application may be output from a vehicle-mounted terminal. For example, as shown in FIG. 5, a mobile terminal connection module 14 is provided instead of the execution platform 12 of the above embodiment in the vehicle-mounted terminal 10. A mobile terminal 30 as an information terminal for executing an application 31 is connected to the mobile terminal connection module 14. That is, the mobile terminal 30 is externally connected to the vehicle-mounted terminal 10. In this way, an output of the application 31 of the mobile terminal 30 is input to the vehicle-mounted terminal 10. Further, an input to the application 31 is output from the vehicle-mounted terminal 10 to the mobile terminal 30. Thus, the application 31 executed in the mobile terminal 30 can be utilized in the vehicle-mounted terminal 10. However, applications 31 that are executed in the mobile terminal 30 are usually not provided with a restriction-during-running function at all. Thus, proper restriction-during-running is not executed in the application 31 during the running of the vehicle merely by executing the application 31 in the mobile terminal 30. Accordingly, in this embodiment, the vehicle-mounted terminal 10 is configured to set the application 31 in the forcible restriction-during-running mode during the running of the vehicle if the application 31 being executed in the mobile terminal 30 is not registered in the vehicle-mounted reviewed application list 5. Specifically, the vehicle-mounted terminal 10 restricts input information to the application 31 and output information from the application 31.

According to the above configuration, the vehicle-mounted terminal 10 can manage the input and output information corresponding to the application 31 executed in the mobile terminal 30 externally connected to the vehicle-mounted terminal 10, according to a vehicle state. If the mobile terminal 30 is not designed to be vehicle mounted, it may not be possible to perform an operation taking into account influence on the vehicle driving operation only by the mobile terminal 30. However, even in the case of utilizing such a mobile terminal 30, the vehicle-mounted terminal 10 configured as described above can manage the input and output information of the application 31 according to the vehicle state. Therefore, the externally connected mobile terminal 30 can be utilized in the vehicle 1 while preventing influence on the vehicle driving operation.

In the above embodiment, the vehicle ECU 20 is connected to the vehicle-mounted terminal 10 via the CAN. The switches 21 are connected to the vehicle-mounted terminal 10 via the LIN. The speaker 22 and the display 23 are connected to the vehicle-mounted terminal 10 via the Ethernet®. However, without being limited to this, any of the CAN, the LIN and the Ethernet® can be appropriately used for each connection. Even other networks such as FlexRay® can be adopted. That is, the flexibility in connection between the vehicle-mounted terminal and other devices is increased.

In the above embodiment, whether or not the restriction-during-running is executed for a delivery-type application 3 is determined based on whether or not the vehicle 1 is in the stopped state. However, without being limited to this, whether or not the restriction-during-running is executed for a delivery-type application may be determined according to the running speed of a vehicle. Specifically, if the running speed of the vehicle is slow, detailed information of road surrounding facilities is, for example, provided to a driver. On the other hand, if the running speed is fast, information simplified from detailed information is provided to the driver. Thus, the flexibility in applying the vehicle-mounted application management device is improved.

In the above embodiment, the vehicle-mounted terminal 10 generates the vehicle-mounted reviewed application list 5 based on the review completion information added to each delivery-type application 3 received from the information center 2. However, without being limited to this, the vehicle-mounted terminal 10 may receive a vehicle-mounted reviewed application list generated by the information center 2 from the information center 2. For example, the information center 2 may generate the vehicle-mounted reviewed application list based on information on delivery-type applications 3 delivered from the information center 2 to the vehicle-mounted terminal 10 stored in the information center 2. Further, the information center 2 may generate the vehicle-mounted reviewed application list by acquiring information on the delivery-type applications 3 retained in the vehicle-mounted terminal 10 from the vehicle-mounted terminal 10. The information center 2 may receive a vehicle-mounted reviewed application list retained in the vehicle-mounted terminal 10, add a new identification number and return the vehicle-mounted reviewed application list to the vehicle-mounted terminal 10. Also by this, the flexibility in generating the vehicle-mounted reviewed application list is increased. The flexibility in designing a vehicle-mounted application management device is increased.

In the above embodiment, the transmission path to be on and off is the input control module 111, the sound control module 112 or the display control module 113. However, without being limited to this, the transmission path to be on and off may be the native function utilization module 133. In this case, the restriction-during-running management module 132 restricts at least one of the operation information, the instruction information, the sound information, the character information and the image information by managing the native function utilization module 133. That is, the restriction-during-running management module 132 may manage the on-off of the native function utilization module 133. If the native function utilization module is configured to collectively restrict a plurality of pieces of information, the management relating to the restriction-during-running (the on-off management) can be performed in a concentrated manner. In the case of such collective restriction, the input control module, the sound control module or the display control module needs not execute the restriction-during-running for each piece of information. Thus, the input control module, the sound control module or the display control module may be incapable of the on-off management by the identification number. In this case, the structures of the input control module, the sound control module and the display control module are simplified.

In the above embodiment, the mode is illustrated in which the identification number of the delivery-type application 3 included in the input information and the output information is recognized to execute the restriction-during-running. However, without being limited to this, the recognition of the identification number for restricting the input information and the output information may be omitted in the following case. For example, if a delivery-type application for receiving input information and outputting output information can be always identified, for example, because there is only one delivery-type application that is executed in the vehicle-mounted terminal, the recognition of the identification number for restricting the input information and the output information may be omitted. In this way, the flexibility in designing the vehicle-mounted application management device is improved.

In the above embodiment, the case is illustrated where the vehicle-mounted terminal 10 is a navigation system. However, there is no limitation to this. As long as the vehicle-mounted terminal is a terminal provided in a vehicle, it may be any one of various vehicle control devices that are operated by a driver or the like and provide video and sound information to the driver or the like. Further, the vehicle-mounted terminal may also be an information processing device such as an audio product. That is, the vehicle-mounted application management device of the present disclosure can be widely applied to vehicle-mounted devices.

1. A vehicle-mounted application management device for managing an application that is executed in an information terminal mounted in a vehicle, the vehicle-mounted application management device comprising a management unit, wherein
the management unit is configured to detect a vehicle state, which is a state of the vehicle, and to manage, based on the detected vehicle state, on-off of at least one of a transmission path of input information that is assigned at execution of the application and a transmission path of output information that is output at execution of the application,
the management unit includes a list in which applications confirmed to include a built-in travel restriction function so as to properly operate in the information terminal are registered,
the management unit is configured to update the list by receiving the updated list from outside or receiving a signal for updating the list from outside, and
the management unit is configured to close the transmission path for an application not registered in the list.

2. The vehicle-mounted application management device according to claim 1, wherein
an output device for converting the output information into perceivable information and outputting the converted output information is mounted in the vehicle, and
the management unit is configured to manage the on-off of the transmission path of the output information to the output device.

3. The vehicle-mounted application management device according to claim 1, wherein
the input information is assigned to the application, and
the management unit is configured to manage the on-off of the transmission path of the input information assigned to the application.

4. The vehicle-mounted application management device according to claim 1, wherein the management unit and the information terminal are integrally provided.

5. The vehicle-mounted application management device according to claim 1, wherein the information terminal is configured to be externally connected to the management unit.

6. The vehicle-mounted application management device according to claim 1, wherein
the management unit includes a list in which applications confirmed to properly operate in the information terminal are registered, and
the management unit is configured to manage the on-off of the transmission pat for applications not registered in the list.

7. The vehicle-mounted application management device according to claim 1, wherein the detected vehicle state is a running speed of the vehicle or a stopped state of the vehicle.

8. The vehicle-mounted application management device according to claim 1, wherein the application is delivered to the vehicle from outside.

9. A vehicle-mounted application management method for managing an application that is executed in an information terminal mounted in a vehicle, the vehicle-mounted application management method comprising:
registering applications confirmed to include a built-in travel restriction function so as to properly operate in the information terminal in a list;
updating the list by receiving the updated list from outside or receiving a signal for updating the list from outside;
acquiring a vehicle state that is a state of the vehicle; and
closing a transmission path for an application not registered in the list to manage on-off of at least one of a transmission path of input information that is assigned at execution of the application and a transmission path of output information that is output at execution of the application.

10. The vehicle-mounted application management method according to claim 9, wherein
an output device for converting the output information into perceivable information and outputting the converted output information is mounted in the vehicle, and
managing the on-off of the transmission path is managing the on-off of the transmission path of the output information to the output device.

11. The vehicle-mounted application management method according to claim 9, wherein
the input information is assigned to the application, and
managing the on-off of the transmission path is managing the on-off of the transmission path of the input information assigned to the application.

12. The vehicle-mounted application management method according to claim 9,
wherein a state where the application about the transmission path, the on-off of which is managed, is being run maintained during the running of the vehicle.

13. The vehicle-mounted application management method according to claim 9, wherein acquiring the vehicle state is acquiring a running speed of the vehicle or whether or not the vehicle is in a stopped state as the acquired vehicle state.
